(19) United States
(12) Patent Application Publication
(10) Pub. No.: US 2020/0207041 A1
(43) Pub. Date: Jul. 2, 2020

(54) APPARATUS FOR MAKING CONICAL BELLOWS

(71) Applicant: ContiTech Luftfedersysteme GmbH, Hannover (DE)

(72) Inventors: Winfried Reisch, Wunstorf (DE); Ruediger Lommatzsch, Isernhagen (DE)

(73) Assignee: ContiTech Luftfedersysteme GmbH, Hannover (DE)

(21) Appl. No.: 16/812,402

(22) Filed: Mar. 9, 2020

Related U.S. Application Data
(62) Division of application No. 16/000,562, filed on Jun. 5, 2018.

(30) Foreign Application Priority Data
Dec. 11, 2015 (DE) 10 2015 224 964.6

(51) Int. Cl. B29D 22/02; B30B 11/00; B29C 33/48

(52) U.S. Cl. CPC B29D 22/023; B29C 33/485; B30B 11/007

(57) ABSTRACT

The invention relates to a device for producing conical bellows (2) for air springs, having at least one clamping/spreading device (9), wherein two terminal positions, specifically an introduction position and a vulcanization position, are attainable by the clamping/spreading device (9), wherein the external diameter of the introduction position is smaller than the external diameter of the vulcanization position. The clamping/spreading device (9) has clamping segments (6) which in the introduction position are converged in such a manner that the external diameter of the clamping/spreading device (9) enables an air spring bellows preform (2) to be pulled over, and the clamping segments (6) in the vulcanization position are diverged in such a manner that the external diameter of the clamping/spreading device (9) is enlarged in such a manner that the air spring bellows preform (2) is capable of being pressed tightly against the corresponding external shape (5) from the inside, wherein open gaps (10) on account of the enlargement of the external diameter of the clamping/spreading device (9) remain between the clamping segments (6).

### CROSS REFERENCE TO RELATED APPLICATIONS

This application is a divisional of application Ser. No. 16/000,562, filed Jun. 5, 2018, which is a continuation application of international patent application PCT/EP2016/073857, filed Oct. 6, 2016, designating the United States and claiming priority from German application 10 2015 224 964.6, filed Dec. 11, 2015, and the entire content of these applications is incorporated herein by reference.

### BACKGROUND OF THE INVENTION

The invention relates to a device for producing conical bellows for air springs, having at least one clamping/spreading device, wherein two terminal positions, specifically an introduction position and a vulcanization position, are attainable by the clamping/spreading device, wherein the external diameter of the introduction position is smaller than the external diameter of the vulcanization position.

When being vulcanized, air spring bellows which can be supported and sealed on adjacent components by way of conical seats are usually supported inside respective molds by so-called heating bellows. DE 195 32217 C1 shows a heating bellows of this type.

### BRIEF SUMMARY OF THE INVENTION

In the vulcanization using heating bellows, pressure and temperature are transmitted by means of hot steam by way of the heating bellows to the preform. It can be readily perceived that the heat required for the cross-linking of the natural rubber in the vulcanization using heating bellows requires more time to reach the preform. For this reason, the vulcanization time of vulcanization without heating bellows is shorter than that of the vulcanization with heating bellows.

This is therefore desirable that bellows having conical seal seats can also be vulcanized without heating bellows.

A respective device which implements the required seals of the bellows preform inside the mold by way of a clamping and spreading device is disclosed in DE 10103257 A1. In the case of this device, two locking-bar and segment systems that are disposed in a reciprocal manner in the relaxed state reduce the external diameter of the device and thus enable the preform to be pulled over. The beads are sequentially tensioned from the inside in a form-fitting manner by spreading the locking bars and segments are thus sealed for the tubeless vulcanization.

However, this device is relatively complex and prone to defects, since the raw rubber in the vulcanization can invade the as yet present gaps of the clamping and spreading device.

The invention is based on the object of modifying a device of the type mentioned at the outset in such a manner that a vulcanization of air spring preforms having a conical seat without heating bellows is significantly simplified.

This object is achieved in that the clamping/spreading device has clamping segments which in the introduction position are converged in such a manner that the external diameter of the clamping/spreading device enables an air spring bellows preform to be pulled over, and the clamping segments in the vulcanization position are diverged in such a manner that the external diameter of the clamping/spreading device is enlarged in such a manner that the air spring bellows preform is capable of being pressed tightly against the corresponding external shape from the inside, wherein open gaps on account of the enlargement of the external diameter of the clamping/spreading device remain between the segments.

The rubber of the bellows preform is softened in the vulcanization such that the bellows preform has protuberances that between the clamping segments of the clamping/spreading device protrude into the interior of the bellows. However, since the bellows preform has at least one reinforcement embedded in the rubber, in most instances a woven textile fabric, the rubber on account thereof is sufficiently supported such that the woven fabric in the protuberances of the bellows in the gaps cannot be pressed through the latter. A flawless vulcanization of the bellows in the interior of the bellows is thus also guaranteed in the configuration of the protuberances.

In one refinement of the invention, the width of the open gaps between the clamping segments of the clamping/spreading device in the vulcanization position is between 1 and 30 mm.

In one refinement of the invention, the width of the open gaps between the clamping segments of the clamping/spreading device in the vulcanization position is between 3 and 25 mm.

Depending on the number of clamping segments and the diameter conditions, these geometries have been demonstrated to be optimal in tests, such that the threads of the reinforcement lie such that said threads cannot be pressed through the rubber. A reliable sealing of the bellows during the vulcanization and the tightness of the bellows in the fully vulcanized state are thus provided.

In one refinement of the invention, the clamping/spreading device has at least three clamping segments.

A particularly non-critical configuration of the protuberances mentioned is evident as from a number of three clamping segments.

### BRIEF DESCRIPTION OF THE SEVERAL VIEWS OF THE DRAWING(S)

An example of the invention is explained in more detail below with reference to the drawing. In the drawing:

FIG. 1 shows a tool, known per se, for vulcanizing air spring bellows, having a bellows preform inserted, in a longitudinal section;

FIG. 2 shows the tool for vulcanizing air spring bellows, having a fully vulcanized air spring bellows, in a longitudinal section;

FIG. 3 shows a plan view of a clamping/spreading device according to the invention, in a converged state; and

FIG. 4 shows the clamping/spreading device in a diverged state.

### DETAILED DESCRIPTION OF THE INVENTION

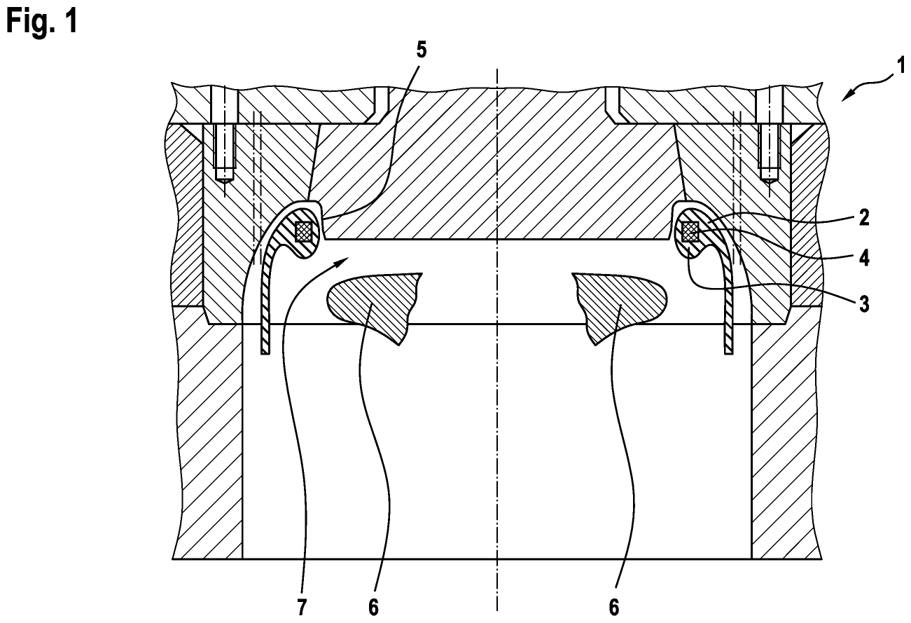

A tool 1, known per se, for vulcanizing air spring bellows is schematically shown in FIG. 1. An air spring preform 2, here shown as an upper portion, has a bead 3 having an embedded core 4. The bead 3 is guided toward a conical shape 5.

Schematically shown clamping segments 6, of which only 2 portions are shown here, of a clamping/spreading device (not illustrated in more detail) are converged in such a manner that the bellows preform 2 by way of the opening 7 of the latter has been capable of being pulled over the clamping segments 6.

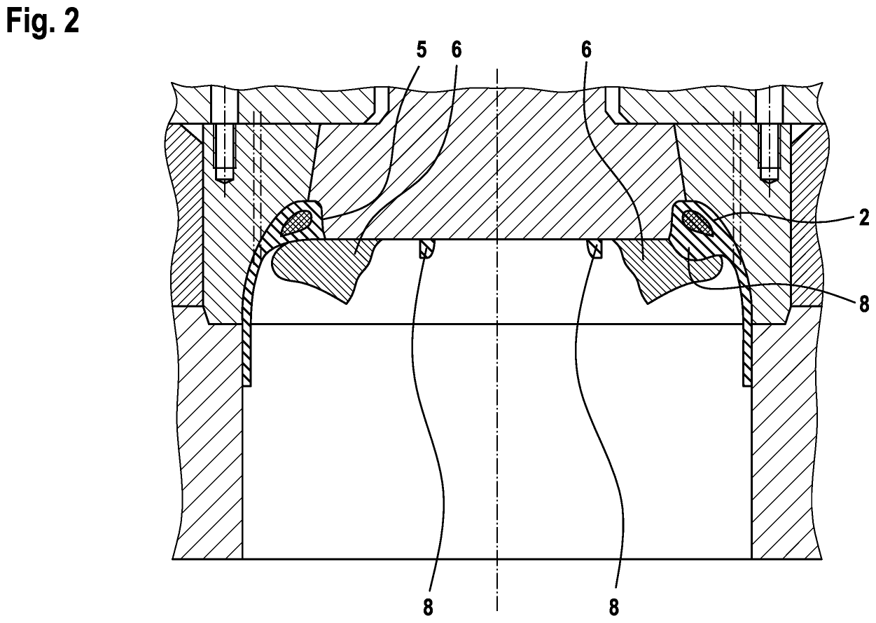

The air spring bellows 2 is shown as a fully vulcanized portion in FIG. 2. The bead 3 by way of the presently diverged clamping segments 6 of the clamping/spreading device is pressed against the conical shape 5 of the tool 1. To this end, the clamping segments 6 are diverged such that a compression of the bead 3 is possible.

Diverging the clamping segments 6 leads to gaps between the individual clamping segments 6, rubber material of the bellows 2 having invaded said gaps in the vulcanization. The gaps are not visible in this illustration. The rubber that has invaded the gaps forms protuberances 8 which are directed toward the interior of the bellows 2.

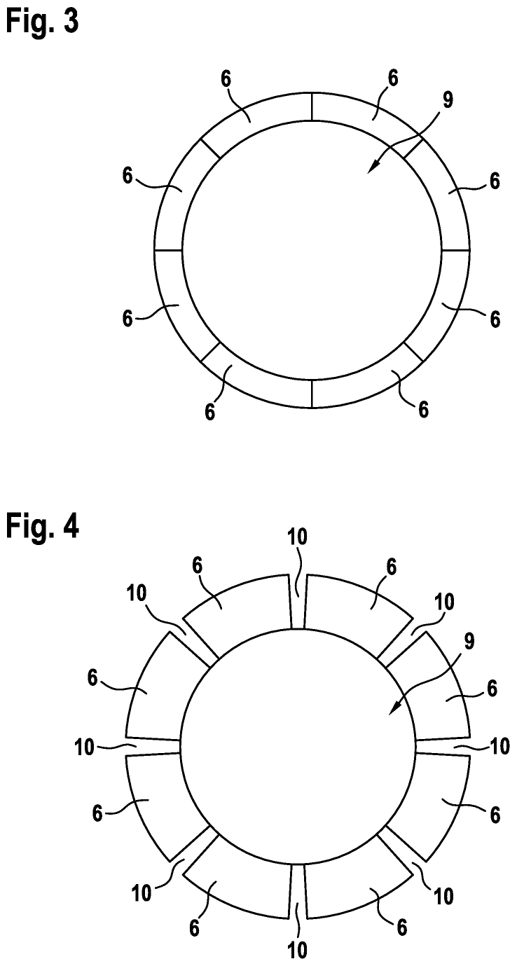

A plan view of a clamping/spreading device 9 according to the invention is shown in FIG. 3. The clamping/spreading device 9 has eight clamping segments 6 which here are shown in a converged state.

The clamping/spreading device 9 is likewise shown in a plan view in FIG. 4. The clamping segments 6 here are illustrated as diverged. The clamping/spreading direction 9 between the clamping segments 6 has gaps 10 which have been created by diverging the clamping segments 6. As is illustrated in FIG. 2, the gaps 10 lead to the protuberances 8 of the rubber material. The protuberances 8 are not visible in FIG. 4.

The device according to the invention enables the vulcanization of air spring bellows without heating bellows in a simple manner, wherein the clamping/spreading device is of a very simple construction.

### LIST OF REFERENCE SIGNS

### Part of the Specification

1 Air spring bellows vulcanizing tool
2 Air spring bellows
3 Bead of the air spring bellows 2
4 Core of the bead 3
5 Conical shape of the tool 1
6 Clamping segments
7 Opening of the air spring bellows 2
8 Protuberances
9 Clamping/spreading device
10 Gaps between the clamping segments 6

1. A method for producing conical bellows for air springs, the method comprising:
initially positioning clamping segments in an introduction position where clamping segments of a tool are converged;
pulling an air springs bellows preform over the converged clamping segments, where the air springs bellows preform includes a bead having an embedded core, the air springs bellows comprising a reinforcement embedded in rubber;
diverging the clamping segments to press the air springs bellows preform tightly against an external shape from an inside of the tool and introducing open gaps between the diverged clamping segments; and
vulcanizing the air springs bellows preform with the diverged clamping segments to form an air springs bellows and forming rubber protuberences in the open gaps where the reinforcement prevents passing through of the air springs bellows within the open gaps.

2. The method of claim 1, wherein the reinforcement comprises a woven textile fabric, where the woven textile fabric in the rubber protuberences that supports the air springs bellows preform within the open gaps to prevent pressing through during the vulcanization.

3. The method of claim 1, wherein vulcanizing comprises vulcanizing without heat.

4. The method of claim 1, further comprising providing a reliable sealing of the air springs bellows preform during the vulcanization by the reinforcement.

5. The method of claim 1, wherein the external shape is a conical shape.

6. The method of claim 1, wherein only a portion of the air springs bellows preform having the embedded core is pulled over the converged clamping segments.

7. The method of claim 1, further comprising converging the clamping segments to form an opening that permits the air springs bellows preform to be at least partially pulled over the converged clamping segments.

8. The method of claim 1, wherein the clamping segments comprises eight individual segments.

9. The method of claim 1, wherein the clamping segments have no gaps in when in the introduction position.

10. The method of claim 1, further comprising providing the tool with a mold having the external shape on an interior surface of the tool, wherein the external shape comprises conical upper edges and wherein the diverged clamping segments press the bead and the embedded bead core into the conical upper edges of the mold.

11. The method of claim 1, further comprising positioning the bead of the air springs bellows preform above the clamping segments prior to the vulcanization.

12. The method of claim 11, further comprising diverging the clamping segments outward and upward to press the clamping segments into the bead of the air springs bellows preform during vulcanizing the air springs bellows preform.

13. The method of claim 1, further comprising providing the clamping segments having a round outer surface configured to press against and form the bead of the air springs bellows preform during vulcanizing the air springs bellows.

14. The method of claim 1, further comprising vulcanizing the air springs bellows preform without hot steam and heating of the air springs bellows preform.

15. The method of claim 14, further comprising performing the vulcanization for a shorter time based on the lack of heating the air springs bellows preform.
